(19) United States
(12) Patent Application Publication
(10) Pub. No.: US 2026/0158568 A1
(43) Pub. Date: Jun. 11, 2026

(54) LINE FOLLOWING POWER TOOL

(71) Applicant: MILWAUKEE ELECTRIC TOOL CORPORATION, Brookfield, WI (US)

(72) Inventors: Robert P. Hodson, Hartford, WI (US); Keil J. Brady, Chicago, IL (US)

(21) Appl. No.: 19/413,683

(22) Filed: Dec. 9, 2025

Related U.S. Application Data
(60) Provisional application No. 63/729,647, filed on Dec. 9, 2024.

(51) Int. Cl. B23D 59/00; B23D 49/10; B23D 49/16; B27C 5/10

(52) U.S. Cl. CPC B23D 59/002; B23D 49/105; B23D 49/162; B27C 5/10

(57) ABSTRACT

A power tool includes a housing from which a handle extends, a foot plate coupled to the housing and configured to contact a workpiece during a cutting operation, a drive assembly having a first motor that is configured to drive a cutter about or along a cutting axis, and a second motor disposed within the housing and configured to move the cutter relative to the foot plate in a direction perpendicular to the cutting axis.

### CROSS-REFERENCE TO RELATED APPLICATIONS

This application claims priority to U.S. Provisional Patent Application No. 63/729,647, filed on Dec. 9, 2024, the entire content of which is incorporated herein by reference.

### FIELD

The present subject matter relates to power tools, and more specifically to jigsaws and routers.

### BACKGROUND

Various power tools, such as jigsaws and routers, allow a user to cut through a workpiece. Some power tools may provide a screen to offer better vision of the cut being performed.

### SUMMARY

The present disclosure provides, in one aspect, a power tool including: a housing from which a handle extends; a foot plate coupled to the housing and configured to contact a workpiece during a cutting operation; a drive assembly having a first motor that is configured to drive a cutter about or along a cutting axis; and a second motor disposed within the housing and configured to move the cutter relative to the foot plate in a direction perpendicular to the cutting axis.

The present disclosure provides, in another aspect, a power tool including: a housing; a foot plate coupled to the housing and configured to contact a workpiece during a cutting operation; a drive assembly having a first motor that is configured to drive a cutter about or along a cutting axis, the cutting axis extending in a first direction perpendicular to the foot plate; and a follower assembly coupled to the cutter and configured to move the cutter relative to the foot plate in a second direction perpendicular to the first direction.

The present disclosure provides, in another aspect, a power tool including: a housing; a foot plate coupled to the housing and configured to contact a workpiece during a cutting operation; a drive assembly having a first motor that is configured to drive a cutter about or along a cutting axis; a follower assembly coupled to the housing and configured to move the cutter relative to the foot plate in a direction perpendicular to the cutting axis; a sensor supported by the housing and configured to detect a line on a workpiece and generate a signal indicating a position of the line; and an electronic control unit configured to receive the signal and actuate the follower assembly so that the cutter follows the line on the workpiece.

Other features and aspects of the subject matter will become apparent by consideration of the following detailed description and accompanying drawings.

### BRIEF DESCRIPTION OF THE DRAWINGS

FIG. 1 is perspective view of a jigsaw in accordance with an embodiment of the subject matter.

FIG. 2 is a cross-sectional view of the jigsaw of FIG. 1, illustrating a cutter.

FIG. 3A is a cross-sectional view of the jigsaw of FIG. 1, illustrating the cutter moved to a first position along a direction that is perpendicular to a cutting axis.

FIG. 3B is a cross-sectional view of the jigsaw of FIG. 1, illustrating the cutter moved to a second position along a direction that is perpendicular to a cutting axis.

FIG. 4 is an enlarged cross-sectional view of the jigsaw of FIG. 1, illustrating a follower mechanism that moves the cutter from the first position to the second position.

FIG. 5 is a perspective view of a router in accordance with another embodiment of the subject matter.

FIG. 6 is a top schematic view of the router of FIG. 5, illustrating a cutter.

FIG. 7 is a top schematic view of the router of FIG. 5, illustrating the cutter moved to a different position along a direction that is perpendicular to a cutting axis.

FIG. 8 is a top schematic view of the router of FIG. 5, illustrating the cutter moved to yet another position along a direction that is perpendicular to a cutting axis.

FIG. 9 is a top schematic view of the router of FIG. 5, illustrating the cutter moved to yet another position along a direction that is perpendicular to a cutting axis.

Before any embodiments of the subject matter are explained in detail, it is to be understood that the subject matter is not limited in its application to the details of construction and the arrangement of components set forth in the following description or illustrated in the following drawings. The subject matter is capable of other embodiments and of being practiced or of being carried out in various ways. Also, it is to be understood that the phraseology and terminology used herein is for the purpose of description and should not be regarded as limiting.

### DETAILED DESCRIPTION

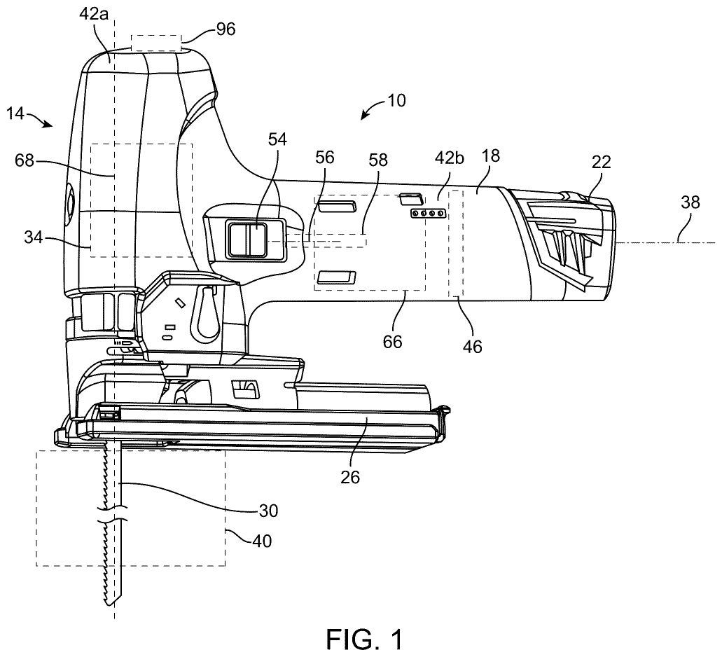

FIG. 1 illustrates a power tool 10 (e.g., a jigsaw), including a housing 14, a handle 18 extending from the housing 14 in a generally transverse direction, a battery 22 (e.g., a 12 volt battery, or other battery size) removably coupled to the handle 18, a foot plate 26 pivotably coupled to the housing 14 and configured to contact a workpiece during a cutting operation, and a cutter 30 protruding from the housing 14 and the lower surface of the foot plate 26. The power tool 10 includes a drive assembly 34 powered by the battery 22 and operable to impart reciprocating motion to the cutter 30 for cutting of a workpiece. The power tool 10 defines a handle axis 38 extending in the direction of, and through, the handle 18. Moreover, the cutter 30 generally reciprocates within a blade plane 40 during a cutting operation.

With reference to FIG. 1, the handle 18 receives the battery 22 along the handle axis 38 and supports an electronic control unit or controller 46. The controller 46 is disposed between the battery 22 and the drive assembly 34 in a direction along the handle axis 38. The power tool 10 also includes gripping surfaces 42a, 42b disposed on the housing 14 and the handle 18, respectively, that are graspable by a user to operate and maneuver the power tool 10 relative to a workpiece. The gripping surfaces 42a, 42b, in addition to the housing 14 and the handle 18, are composed of a non-conductive material (e.g., plastic with or without an elastomeric overmold). Such a non-conductive material electrically insulates the user should the user inadvertently cut an electrical wire during a cutting operation, thus inhibiting, or at least mitigating, an electrical shock.

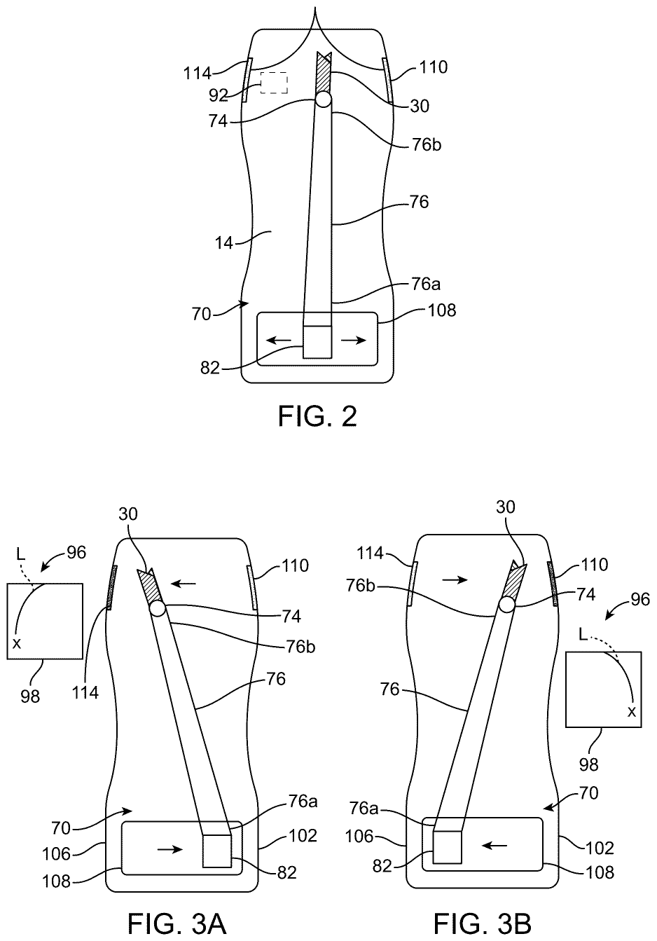

With continued reference to FIGS. 1 and 2, the power tool 10 further includes an activation switch 54 in electrical communication with the controller 46 to selectively supply power to the drive assembly 34. Specifically, the activation switch 54 provides an input to the controller 46 which, in turn, directs electrical current from the battery 22 to the drive assembly 34. The activation switch 54 is provided adjacent the handle 18 and is slidable along a switch axis 56 between an activated state, in which the battery 22 supplies electrical current to the drive assembly 34, and a deactivated state, in which the drive assembly 34 is deactivated. The switch axis 56 is parallel to the handle axis 38 of the power tool 10 (FIG. 1). The activation switch 54 is coupled to a linkage 58 that is disposed on the interior of the housing 14 and is moveable with the activation switch 54. The linkage 58 is parallel to the handle axis 38 and is configured to activate the drive assembly 34 when the activation switch 54 is moved.

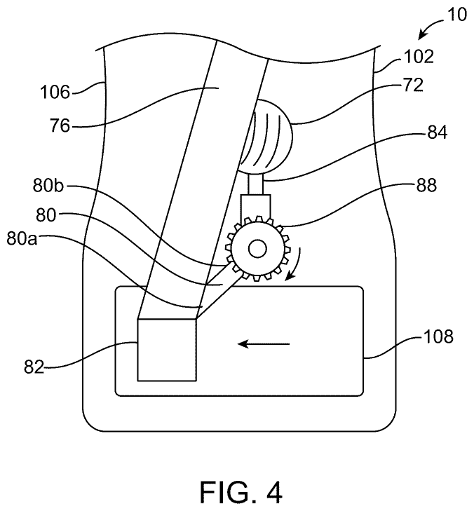

With reference to FIGS. 3 and 4, the drive assembly 34 includes a first motor 66 (e.g., a brushless direct current motor), both of which are disposed within the housing 14. The drive assembly 34 converts rotational motion of the first motor 66 to a reciprocating motion of the cutter 30 along a cutting axis, or vertical axis 68, during a cutting mode. The vertical axis 68 is perpendicular to the handle axis 38.

With reference to FIGS. 2-4, the power tool 10 further includes a follower mechanism 70 that is disposed within the housing 14 and coupled to the cutter 30. The follower mechanism 70 is configured to move the cutter 30 in a direction perpendicular to the vertical axis 68, such that the blade plane 40 moves relative to the housing 14. Specifically, the follower mechanism 70 is configured to move the cutter 30 between a first position (FIG. 3A), a second position (FIG. 3B), and any position between the first and second positions. With reference to FIG. 4, the follower mechanism 70 includes a second motor 72 (e.g., a servo motor), a first linkage 76 pivotably coupled to the cutter 30 at a pivot point 74, and a second linkage 80 pivotably coupled to the first linkage 76. Specifically, a first end 76a of the first linkage 76 is pivotably coupled to the second linkage 80 and a second end 76b of the first linkage 76 is pivotably coupled to the cutter 30. The second motor 72 includes a motor shaft 84 that drives a gear mechanism 88 to convert the rotational motion of the second motor 72 to a translational motion of the second linkage 80. The second linkage 80 is also coupled between the gear mechanism 88 and the first linkage 76, as best illustrated in FIG. 4. Specifically, a first end 80a of the second linkage 80 is pivotably coupled to the first linkage 76 at the pivot joint 82 and a second end 80b is coupled to the gear mechanism 88.

With continued reference to FIGS. 2-4, the power tool 10 further includes a visual sensor 92 that is coupled to the housing 14 and disposed adjacent the cutter 30. Preferably, the visual sensor 92 has a direct line of sight to the cutter 30 and a line L on a workpiece. The visual sensor 92 detects the line L on a workpiece, which is made from any line marking utensil (e.g., marker, pencil, pen, etc.), so long as the contrast is high between the workpiece and the line L. The visual sensor 92 is electrically connected to and configured to send signals to the controller 46. Furthermore, a display (e.g., an LCD screen 96) is coupled to the housing 14 and electrically connected to the controller 46. The LCD screen 96 receives signals from the controller 46 to schematically illustrate a location of the cutter 30 (represented by X) relative to the line L on a workpiece based on the signals being sent from the visual sensor 92. The LCD screen 96 also illustrates a boundary 98, which is indicative of the extent the cutter 30 can move relative to the housing 14 in a direction perpendicular to the vertical axis 68. That is, if the LCD screen 96 schematically illustrates the line L outside the boundary (or no longer schematically illustrates the line L altogether), then the cutter 30 is no longer capable of following the line L on the workpiece.

During operation, a user may grasp the gripping surfaces 42a, 42b of the housing 14 and the handle 18 to maneuver the power tool 10 relative to a workpiece. The user may rest the power tool 10 on the workpiece via the foot plate 26 and align the cutter 30 with the line L on the workpiece. The cutter 30 reciprocates within the blade plane 40 in response to the user sliding the activation switch 54 into the activated state. Once the first motor 66 is activated, the first motor 66 drives reciprocating movement of the cutter 30 along the vertical axis 68 during the cutting mode. The visual sensor 92 detects the line L drawn on the workpiece and the LCD screen 96 schematically illustrates the cutter 30 (represented by X) relative to the line L. The controller 46 is programmed to actuate the follower mechanism 70, so that the cutter 30 follows the line L drawn on the workpiece. Specifically, if the cutter 30 is not aligned with the line L drawn on the workpiece, the second motor 72 is activated to drive the motor shaft 84 and the gear mechanism 88 in a first rotational direction or a second, opposite rotational direction which, in turn, actuates (i.e., translates) the second linkage 80. The second linkage 80 is pivotably coupled to the first linkage 76 via a pivot joint 82, and therefore, actuation of the second linkage 80 causes actuation of the first linkage 76. That is, the pivot joint 82 connects the first linkage 76 to the second linkage 80. When the first end 76a of the first linkage 76 moves to a first side 102 (i.e., right side based on a frame of reference of FIG. 3A) of the housing 14, the second end 76b moves to a second side 106 (i.e., left side based on a frame of reference of FIG. 3A) of the housing 14. Thus, the cutter 30 is also moved toward the second side 106 of the housing 14. Similarly, when the first end 76a of the first linkage 76 moves to the second side 106 (i.e., left side based on a frame of reference of FIG. 3B) of the housing 14, the second end 76b moves to the first side 102 (i.e., right side based on a frame of reference of FIG. 3B) of the housing 14. Thus, the cutter 30 is also moved toward the first side 102 of the housing 14. Meanwhile, the pivot joint 82 also moves between the first side 102 and the second side 106 along a track 108 to guide the movement of the pivot joint 82.

In a situation where the cutter 30 moves immediately adjacent the first side 102 of the housing 14 as the cutter 30 is following the line L drawn on the workpiece, a first indicator 110 is activated to alert the user that the cutter 30 can no longer move any further toward the first side 102, suggesting to the user that course correction or adjustment of the power tool 10 is required to continue following the line L drawn on the workpiece. In contrast, when the cutter 30 moves immediately adjacent the second side 106 of the housing 14 as the cutter 30 is following the line L drawn on the workpiece, a second indicator 114 is activated to alert the user that the cutter 30 can no longer move any further toward the second side 106, suggesting to the user that course correction of the power tool 10 is required to continue following the line L drawn on the workpiece. The first and second indicators 110, 114 of the illustrated embodiment are light-emitting diodes (LEDs). The first indicator 110 (i.e., first LED) is disposed on the first side 102 of the housing 14 and the second indicator 114 (i.e., second LED) is disposed on the second side 106 of the housing 14. The first and second indicators 110, 114 are configured to emit green light when the cutter 30 can move in any direction perpendicular to the vertical axis 68 (FIG. 2). However, the first indicator 110 emits red light when the cutter 30 can no longer move any further toward the first side 102 of the housing 14 (FIG. 3B). Also, the second indicator 114 emits red light when the cutter 30 can no longer move any further toward the second side 106 of the housing 14 (FIG. 3A).

Although the first and second indicators 110, 114 of the illustrated embodiment are LEDs, in other embodiments, the first and second indicators 110, 114 may alternatively be other visual, haptic, or other real-time indicator to signal the user that course correction is required for the power tool 10 to continue following the line L drawn on the workpiece.

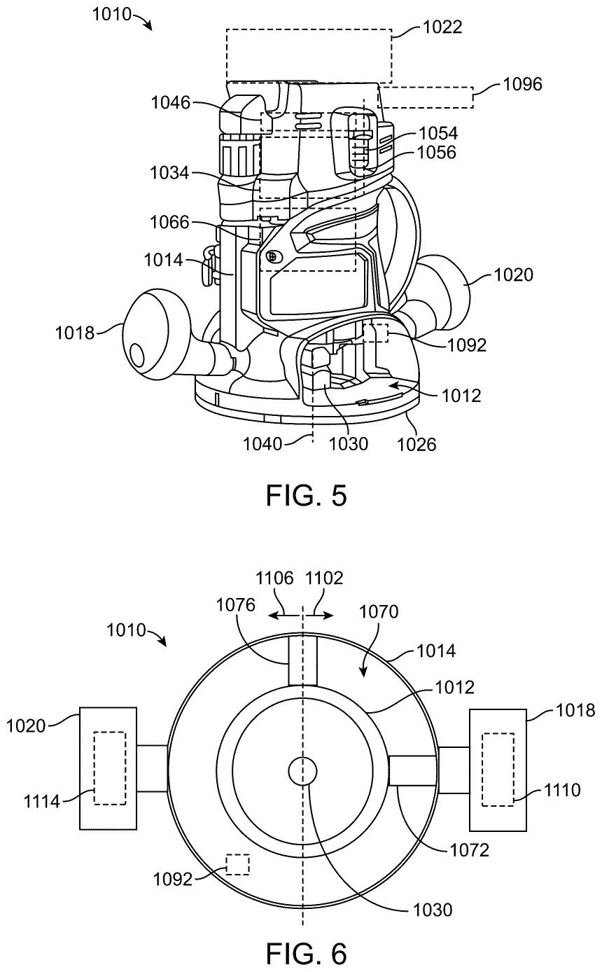

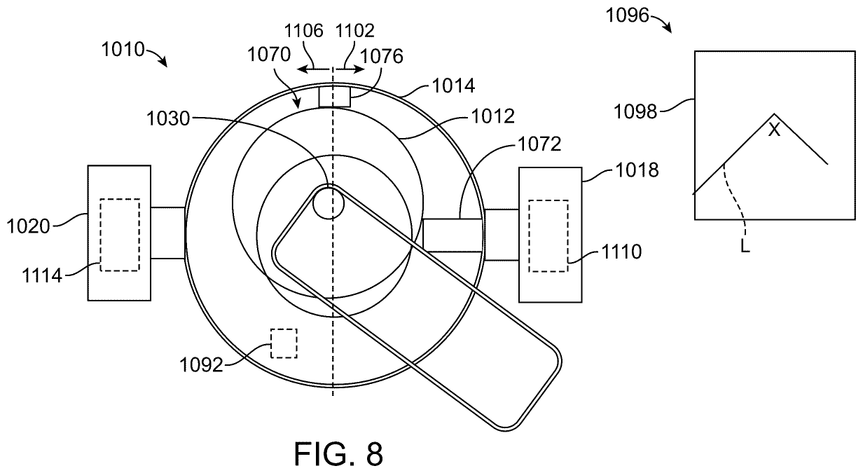

FIGS. 5-9 illustrate a power tool 1010 (e.g., a router) in accordance with another embodiment, with like features being given reference numerals, plus 1000. The differences between the power tool 10 and the power tool 1010 are described in detail below.

With reference to FIGS. 5 and 6, the power tool 1010 includes a motor unit 1012, a fixed base 1014 (FIG. 6), handles 1018, 1020 extending from the fixed base 1014 in a generally transverse direction, a foot plate 1026 coupled to the fixed base 1014 and configured to contact a workpiece during a cutting operation, and a cutter 1030 protruding from the fixed base 1014 and the lower surface of the foot plate 1026. The motor unit 1012 includes a drive assembly 1034 powered by the battery 1022 and operable to impart rotational motion to the cutter 1030 for cutting of a workpiece. Moreover, the cutter 1030 generally rotates about a cutting axis 1040 during a cutting operation.

With continued reference to FIGS. 5 and 6, the fixed base 1014 receives the battery 1022 and supports an electronic control unit or controller 1046. The controller 1046 is disposed between the battery 1022 and the drive assembly 1034. The handles 1018, 1020 are graspable by a user to operate and maneuver the power tool 1010 relative to a workpiece and are composed of a non-conductive material (e.g., plastic with or without an elastomeric overmold). Such a non-conductive material electrically insulates the user should the user inadvertently cut an electrical wire during a cutting operation, thus inhibiting, or at least mitigating, an electrical shock.

With continued reference to FIGS. 5 and 6, the power tool 1010 further includes an activation switch 1054 in electrical communication with the controller 1046 to selectively supply power to the drive assembly 1034. Specifically, the activation switch 1054 provides an input to the controller 1046 which, in turn, directs electrical current from the battery 1022 to the drive assembly 1034. The activation switch 1054 is slidable along a switch axis 1056 between an activated state, in which the battery 1022 supplies electrical current to the drive assembly 1034, and a deactivated state, in which the drive assembly 1034 is deactivated.

With reference to FIGS. 5 and 6, the drive assembly 1034 includes a first motor 1066 (e.g., a brushless direct current motor) this is disposed within the fixed base 1014. The power tool 1010 further includes a follower mechanism 1070 (FIG. 6) that is disposed within the fixed base 1014 and coupled to the cutter 1030. The follower mechanism 1070 is configured to move the cutter 1030 in a direction perpendicular to the cutting axis 1040. Specifically, the follower mechanism 1070 includes a second motor 1072 (e.g., a servo motor), and a third motor 1076 (e.g., a servo motor). The second and third motors 1072, 1076 are disposed between the motor unit 1012 and the fixed base 1014, and are oriented perpendicular relative to each other. The illustrated second and third motors 1072, 1076 actuate plungers while, in other embodiments, the second and third motors 1072, 1076 may alternatively actuate cams or other similar mechanisms. The second motor 1072 actuates the motor unit 1012 along a first direction and the third motor 1076 actuates the motor unit 1012 along a second direction that is perpendicular to the first direction. In combination, the second and third motors 1072, 1076 actuate simultaneously to move the motor unit 1012 in any direction within a horizontal reference plane shown in FIG. 6.

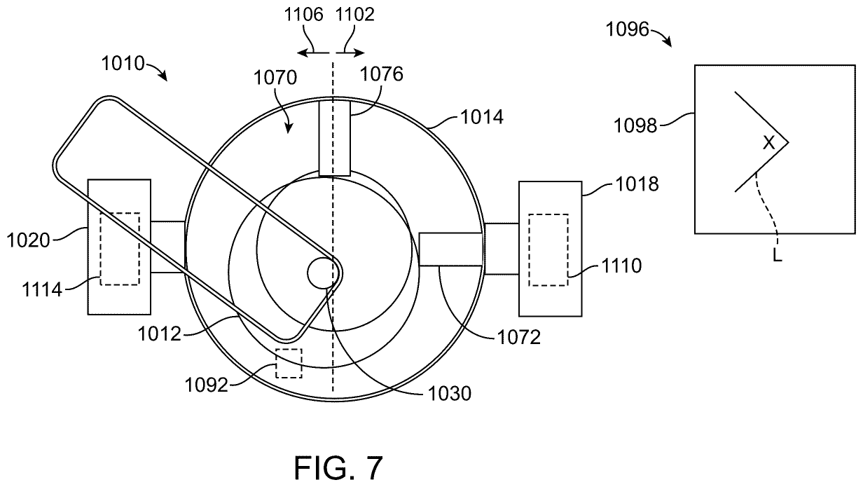

With continued reference to FIGS. 5-6, the power tool 1010 further includes a visual sensor 1092 that is coupled to the fixed base 1014 and disposed adjacent the cutter 1030. Preferably, the visual sensor 1092 has a direct line of sight to the cutter 1030 and a line L on a workpiece. The visual sensor 1092 detects the line L on a workpiece, which is made from any line marking utensil (e.g., marker, pencil, pen, etc.), so long as the contrast is high between the workpiece and the line L. The visual sensor 1092 is electrically connected to and configured to send signals to the controller 1046. Furthermore, an LCD screen 1096 is coupled to the fixed base 1014 and electrically connected to the controller 1046. The LCD screen 1096 receives signals from the controller 1046 to schematically illustrate a location of the cutter 1030 (represented by X) relative to the line L on a workpiece based on the signals being sent from the visual sensor 1092. The LCD screen 1096 also illustrates a boundary 1098 (FIG. 7), which is indicative of the extent the cutter 1030 can move relative to the fixed base 1014 in a direction perpendicular to the cutting axis 1040. That is, if the LCD screen 1096 schematically illustrates the line L outside the boundary (or no longer schematically illustrates the line L altogether), then the cutter 1030 is no longer capable of following the line L on the workpiece.

During operation, a user may grasp the handles 1018, 1020 to maneuver the power tool 1010 relative to a workpiece. The user may rest the power tool 1010 on the workpiece via the foot plate 1026 and align the cutter 1030 with the line L on the workpiece. The cutter 1030 rotates in response to the user sliding the activation switch 1054 into the activated state. Once the first motor 1066 is activated, the first motor 1066 drives the cutter 1030 about the cutting axis 1040 during the cutting mode. The visual sensor 1092 detects the line L drawn on the workpiece and the LCD screen 1096 schematically illustrates the cutter 1030 (represented by X) relative to the line L. The controller 1046 is programmed to actuate the follower mechanism 1070, so that the cutter 1030 follows the line L drawn on the workpiece. Specifically, if the cutter 1030 is not aligned with the line L drawn on the workpiece, the second and third motors 1072, 1076 are activated to either extend or retract the plungers, which move the cutter 1030 relative to the fixed base 1014 in a direction perpendicular to the cutting axis 1040. When the second motor 1072 retracts, the motor unit 1012 and the cutter 1030 move to a first side 1102 (i.e., adjacent the handle 1018) of the fixed base 1014. Similarly, when the second motor 1072 extends, the motor unit 1012 and the cutter 1030 move to a second side 1106 (i.e., adjacent the handle 1020) of the housing 14.

In a situation where the cutter 1030 moves immediately adjacent to the first side 1102 of the fixed base 1014 as the cutter 1030 is following the line L drawn on the workpiece, a first indicator 1110 is activated to alert the user that the cutter 1030 can no longer move any further toward the first side 1102, suggesting to the user that course correction of the power tool 1010 is required to continue following the line L drawn on the workpiece. In contrast, when the cutter 1030 moves immediately adjacent the second side 1106 of the fixed base 1014 as the cutter 1030 is following the line L drawn on the workpiece, a second indicator 1114 is activated to alert the user that the cutter 1030 can no longer move any further toward the second side 1106, suggesting to the user that course correction of the power tool 1010 is required to continue following the line L drawn on the workpiece. The first and second indicators 1110, 1114 of the illustrated embodiment are haptic style indicators that vibrate the handles 1018, 1020. That is, the first indicator 1110 (i.e., first haptic feedback indicator) vibrates the first handle 1018 and the second indicator 1114 (i.e., second haptic feedback indicator) vibrates the second handle 1020.

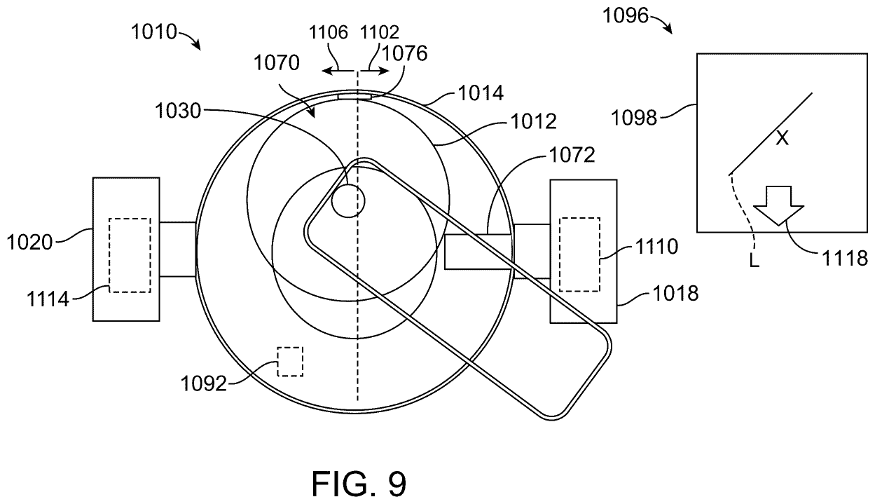

Although the first and second indicators 1110, 1114 of the illustrated embodiment are haptic style indicators, in other embodiments, the first and second indicators 1110, 1114 may alternatively be visual (i.e., LEDs) or other real-time indicator to signal the user that course correction is required for the power tool 1010 to continue following the line L drawn on the workpiece. The LED screen 1096 may also display an indicator 1118 (FIG. 9) suggesting to the user that course correction of the power tool 1010 is required to continue following the line L drawn on the workpiece.

Although the subject matter has been described in detail with reference to certain preferred embodiments, variations and modifications exist within the scope and spirit of one or more independent aspects of the subject matter as described. Various features of the subject matter are set forth in the following claims.

What is claimed is:

1. A power tool comprising:
a housing from which a handle extends;
a foot plate coupled to the housing and configured to contact a workpiece during a cutting operation;
a drive assembly having a first motor that is configured to drive a cutter about or along a cutting axis; and
a second motor disposed within the housing and configured to move the cutter relative to the foot plate in a direction perpendicular to the cutting axis.

2. The power tool of claim 1, further comprising a battery selectively coupled to the handle.

3. The power tool of claim 2, wherein the second motor is a servo motor.

4. The power tool of claim 1, further comprising a display coupled to the housing upon which a user can follow a line drawn on the workpiece.

5. The power tool of claim 1, further comprising:
a sensor configured to detect a line drawn on the workpiece; and
an electronic control unit configured to receive an input signal from the sensor and, in response to the input signal, move the cutter in a direction perpendicular to the cutting axis to follow the line.

6. The power tool of claim 1, further comprising a third motor disposed within the housing, the second motor and the third motor configured to move the cutter relative to the foot plate in the direction perpendicular to the cutting axis.

7. A power tool comprising:
a housing;
a foot plate coupled to the housing and configured to contact a workpiece during a cutting operation;
a drive assembly having a first motor that is configured to drive a cutter about or along a cutting axis, the cutting axis extending in a first direction perpendicular to the foot plate; and
a follower assembly coupled to the cutter and configured to move the cutter relative to the foot plate in a second direction perpendicular to the first direction.

8. The power tool of claim 7, wherein the follower assembly includes a second motor mechanically coupled to the cutter.

9. The power tool of claim 8, wherein the follower assembly further includes a third motor mechanically coupled to the cutter.

10. The power tool of claim 9, wherein the second motor and the third motor are servo motors.

11. The power tool of claim 8, wherein the follower assembly includes a first linkage coupled to the second motor, and a second linkage having a first end pivotally coupled to the first linkage at a pivot joint and a second end coupled to the cutter.

12. The power tool of claim 11, wherein the pivot joint is supported by a track to guide movement of the pivot joint between a first side and a second side of the track.

13. The power tool of claim 11, wherein the follower assembly further includes a gear assembly coupled to the second motor and to the first linkage, and wherein the gear assembly converts rotation of the second motor to pivotal translation of the first linkage.

14. A power tool comprising:
a housing;
a foot plate coupled to the housing and configured to contact a workpiece during a cutting operation;
a drive assembly having a first motor that is configured to drive a cutter about or along a cutting axis;
a follower assembly coupled to the housing and configured to move the cutter relative to the foot plate in a direction perpendicular to the cutting axis;
a sensor supported by the housing and configured to detect a line on a workpiece and generate a signal indicating a position of the line; and
an electronic control unit configured to receive the signal and actuate the follower assembly so that the cutter follows the line on the workpiece.

15. The power tool of claim 14, wherein the sensor is a visual sensor.

16. The power tool of claim 15, wherein the sensor has a line of sight to the line and to the cutter.

17. The power tool of claim 14, wherein the housing supports a display that is electrically connected to and receives signals from the electronic control unit and illustrates a location of the cutter relative to the line.

18. The power tool of claim 14, further comprising an indicator supported in the housing, the electronic control unit activating the indicator to alert a user to adjust a course of the power tool.

19. The power tool of claim 18, wherein the indicator is a light-emitting indicator.

20. The power tool of claim 18, wherein the indicator is a haptic indicator.
